(19) United States
(12) Patent Application Publication
(10) Pub. No.: US 2004/0102872 A1
(43) Pub. Date: May 27, 2004

(54) Method and tool for power plant operational optimization

(76) Inventors: Louis Andrew Schick, Delmar, NY (US); Vinay Bhaskar Jammu, Hyderabad (IN); Stephen Duane Sanborn, Copake, NY (US)

Correspondence Address: CANTOR COLBURN, LLP, 55 GRIFFIN ROAD SOUTH, BLOOMFIELD, CT, 06002

(21) Appl. No.: 10/065,860

(22) Filed: Nov. 26, 2002

(51) Int. Cl. G05D 17/00

(52) U.S. Cl. 700/286

(57) ABSTRACT

A method for analyzing operational performance of industrial power plant machinery is disclosed. In an exemplary embodiment, the method includes receiving an input configuration for a power plant to be analyzed, and receiving inputted power plant operational information. A simulated power plant operation is then run for a specified period of time, based upon the power plant input configuration and the inputted power plant operational information. The simulated results of the simulated power plant operation are then outputted in accordance with selected economic parameters of the power plant.

### BACKGROUND OF INVENTION

The present disclosure relates generally to the operation and maintenance of industrial power plant machinery and, more particularly, to a method and tool for simulating and performing trade-off analysis between operational performance and life of industrial power plant machinery. The tool also provides the capability of performing cost-benefit analyses of applying various configurations, modifications, and uprates to the power plant for profit maximization.

Gas turbines generally include a compressor and turbine arranged on a rotating shaft(s), and a combustion section between the compressor and turbine. The combustion section burns a mixture of compressed air and liquid and/or gaseous fuel to generate a high-energy combustion gas stream that drives the rotating turbine. The turbine rotationally drives the compressor and provides output power. Industrial gas turbines are often used to provide output power to drive an electrical generator or motor. Other types of gas turbines may be used as aircraft engines, on-site and supplemental power generators, and for other applications.

Gas turbines have many parts and components that are exposed to corrosive combustion gases, extreme temperatures, centrifugal stresses and other adverse conditions. These conditions impose stresses and corrosive elements on the gas turbine that in turn cause wear, strain, fatigue, corrosion and other harmful effects. Moreover, the major rotating components (i.e., the shaft, turbine and compressor) sustain stresses and are critical to the operation of the gas turbine.

In operation, the compressor, combustion section and turbine form a gas path for the air and combustion gases that flow through the gas turbine. These gas path components withstand extremely high-energy loads, temperatures and corrosive gases. The elevated temperatures, high stresses and aggressive environmental conditions create time-dependent and cyclic failure mechanisms that act on the gas turbine, and especially the gas path components of the gas turbine. These conditions can ultimately lead to failure of components of the gas turbine and, possibly, failure of the gas turbine itself.

Certain gas turbine components generally require significant attention to maintenance are those associated with the combustion process and include, for, example, combustion chambers (cans), combustion liners, end caps, crossfire tubes, turbine nozzles, turbine buckets, etc. These “hot gas path” components tend to be those that require regular replacement, and are thus the subject of regular preventive maintenance and replacement programs. In addition, other basic gas turbine components, such as control devices, fuel metering equipment, gas turbine auxiliaries, load packages, and other station auxiliaries also require periodic servicing.

Accordingly, preventive maintenance measures safeguard industrial gas turbines from failure and undue wear of components. Such preventative maintenance necessarily requires a maintenance schedule to be established for each gas turbine, based on the operating history of the gas turbine. The technicians who operate the gas turbines maintain detailed and comprehensive logs of their operation, including the start-stop times, operating conditions, fuel, load and other conditions. Using these logs, the technicians and supervising engineers monitor the operation of the gas turbine and schedule preventive maintenance and parts replacements. In recent years, control systems for gas turbines have been developed that collect data from sensors on the turbine. This data reflects the operating condition of the gas turbine, in a manner similar to the data manually logged by earlier technicians. Thus, some of the manual logging of operating conditions have been replaced by automatic data collecting control systems.

Manufacturers of gas turbines typically provide instructional manuals on to how to monitor the gas turbine and schedule maintenance and repairs. For example, the Power System Division of the General Electric Company provides a manual entitled “Heavy-Duty Gas Turbine Operating and Maintenance Considerations” (GER-3620G) that explains how to create maintenance schedules for gas turbines and how to conduct preventive maintenance. By following the instructions described in the manual, a technician evaluates the logged operating history of a gas turbine and determines when and what preventive maintenance should be performed.

Prior techniques for scheduling maintenance for industrial gas turbines relied on algorithms that predicted the expected operating life of various components of the turbine. These algorithms for predicting component life are typically based on a defined “design duty cycle”, which is a standardized operational cycle for the gas turbine or one of its components. The design duty cycle is used to predict the deterioration of parts in a gas turbine during a standard cycle of starting, a power production (which may be constant or variable) period and shutdown. The design duty cycle simulates the actual deterioration of parts in a gas turbine operating under conditions for the turbine was designed. However, the design duty cycle does not truly reflect the actual operating conditions of a gas turbine, as the actual operating conditions are often substantially different than those for which the gas turbine was designed.

The actual maintenance requirements of a gas turbine depend on its actual operational history, which includes the actual operating conditions. The actual life of a gas turbine is a strong function of actual usage of the turbine. Off-design operating conditions and off-design modes (e.g., operating conditions substantially different than duty cycle conditions) affect metal temperatures and stresses, and result in more (or less) than predicted damage to the gas turbine. To reflect such off-design conditions, prior techniques have used “maintenance factors” to supplement the duty cycle analysis. Maintenance factors quantify the severity of off-design operation, and have been manually determined by gas turbine technicians and engineers.

Conventional methods of predicting part failure for gas turbines and scheduling maintenance have not been entirely accurate in either predicting part failures and/or optimally scheduling maintenance. The traditional “duty cycle” used for predictive maintenance does not reflect real operational conditions, especially off-design operations. The actual life of a component of a gas turbine depends strongly on the actual usage of that gas turbine and the part within the turbine. For example, elevated temperatures and stresses within the turbine, and aggressive environmental conditions may cause excessive wear on components in the turbine beyond that predicted with the standard design duty cycle. Off-design operating conditions, which are often experienced by industrial gas turbines, are not reflected by the standard duty cycles. The actual part life of components in the gas turbine may be substantially less than that predicted by the design duty cycle. Alternatively, if more favorable conditions are experienced by an actual gas turbine (than are reflected in the design duty cycle), the actual part life may last substantially longer than that predicted by maintenance schedules based on the design duty cycle. In either event, the standard “design duty cycle” model for predicting preventive maintenance in industrial gas turbines does not reliably indicate the actual wear and tear experience by a gas turbine.

However, prior techniques for predicting maintenance and part replacement relied on skilled technicians to acquire or interpret data regarding the operation of a gas turbine. Such techniques were subject to the varying interpretations of that data by technicians. The operational logs and/or data collected from gas turbines were manually evaluated by technicians. Technicians, for example, would evaluate start and stop times, and power settings to determine how many duty cycles had been experienced by the gas turbine, their frequency, period and other factors. In addition, if the log data of the gas turbine indicated that extraordinary conditions existed, such as excessive temperatures or stresses, the technicians would apply “maintenance factors” to quantify the severity of these off-design operational conditions.

Accordingly, there is a need for a more accurate means of determining the life of a gas turbine and its components. In so doing, there then exists the potential for improving the operating profile of a power plant to optimize plant performance and/or component life, thereby increasing profits.

### SUMMARY OF INVENTION

The above discussed and other drawbacks and deficiencies of the prior art are overcome or alleviated by a method for analyzing operational performance of industrial power plant machinery. In an exemplary embodiment, the method includes receiving an input configuration for a power plant to be analyzed, and receiving inputted power plant operational information. A simulated power plant operation is then run for a specified period of time, based upon the power plant input configuration and the inputted power plant operational information. The simulated results of the simulated power plant operation are then outputted in accordance with selected economic parameters of the power plant.

In another aspect, a simulation tool for analyzing operational performance of industrial power plant machinery includes a user interface for inputting a power plant configuration and for inputting power plant operational information. A simulation engine runs a simulated power plant operation for a specified period of time, based upon the power plant configuration and said power plant operational information, wherein simulated results of the simulated power plant operation are outputted in accordance with selected economic parameters of the power plant.

### BRIEF DESCRIPTION OF DRAWINGS

Referring to the exemplary drawings wherein like elements are numbered alike in the several Figures:

FIG. 1 is a block diagram illustrating a method for simulating and analyzing operational performance of industrial power plant machinery, in accordance with an embodiment of the invention;

FIG. 2 is a block diagram illustrating the functional overview of the simulation engine portion of a web-based simulation tool configured in accordance with the method of FIG. 1;

FIG. 3 is an exemplary screen shot of a login screen that may be used to access the simulation tool;

FIG. 4 is an exemplary screen shot of a home screen accessed after login;

FIG. 5 is an exemplary screen shot of a plant configuration option;

FIG. 6 is an exemplary screen shot for editing a default scenario;

FIG. 7 is an exemplary screen shot of a component edit feature in which parameters of an individual turbine generator component may inputted/edited;

FIG. 8 is a graph illustrating an exemplary operation profile for the purpose of maximizing revenue;

FIG. 9 is an exemplary simulation output of a scenario in which the benefits of procuring an improved compressor are assessed in view of a potential return on investment (ROI); and

FIG. 10 is a pair of bar charts illustrating and comparing a variety of plant operating scenarios.

### DETAILED DESCRIPTION

Disclosed herein is a web-based, power plant simulation tool that allows a user to perform various simulations in order to study the trade off between parts lives and performance for a power generation system, thereby assisting in maximizing profits. Briefly stated, the simulation tool integrates power plant performance modeling software and component lifing modeling software with user inputted operating conditions/rules to run various operating scenarios. The results of these scenarios are graphically summarized for the user such that the user may then make decisions (e.g., component upgrades) that affect the profitability of the power plant system, based upon the estimated return on investment (ROI).

As will be described in greater detail hereinafter, the power plant simulation tool allows the user to configure a simulated power plant (e.g., a combined cycle power plant with a specified number of “blocks”, with each block including a specified number of components such as gas turbines, steam turbines, condensers, etc.). Then, additional information used for plant operation is entered by the user such as, for example, fuel price, electricity price, parts price/specifications and inspection costs. An operation profile for the plant is then selected based upon electricity prices at a given instant in time, which in turn dictate to the plant operator to put the plant into one of a plurality of operation modes such as base load, peak load or steam augmentation mode(s). The simulation tool is then run to simulate plant operation for a specified period of time, and the results are analyzed to help identify the best trade off between parts costs/lives and performance. Although the embodiments described herein are presented in the context of a gas turbine power generation system, it will be appreciated that the principles of the simulation tool are equally applicable to alterative power generation systems.

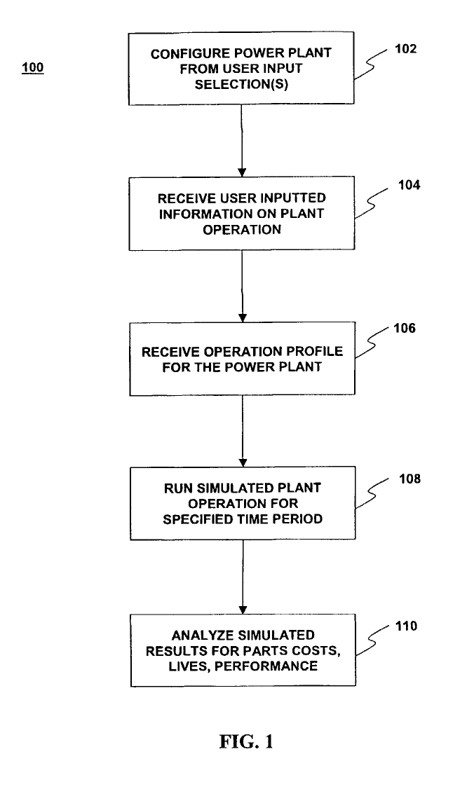

Referring initially to FIG. 1, there is shown a block diagram illustrating a method 100 for simulating and analyzing operational performance of industrial power plant machinery, in accordance with an embodiment of the invention. Method 100 begins with step 102, in which a virtual power plant is configured, based upon a selection received through a user input. The power plant model in turn is based upon a set of objects (i.e., components) that are associated with one another to form the virtual power plant. The individual components are given attributes such as cost, degradation rate, repair interval, performance constraints, and collateral maintenance. Thereby, such attributes are sufficient to make several associated components “behave” as turbines and turbine sections (for example) in a block from which complete plants are assembled.

Method 100 continues with step 104, in which user inputted information regarding plant information is received. This information may include both dynamic and fixed plant inputs. Appropriate examples of dynamic plant inputs include electricity cost and fuel price, while examples of fixed plant inputs include inspection costs, parts costs, design life, degradation rates, and heat rate improvements. In addition, the plant information may further include any constraints (contractual or otherwise) placed on the subject power system, such as minimum required steam, maximum power generated on the grid, maximum exhaust gas output, inspection/outage constraints, etc.

At step 106, a selected operational profile for the power plant is received from the user. The operational profile establishes how the plant is to be operated, and may be selected from a variety of operating modes (e.g., base load, peak load, part load, off, etc.). Once this information is received, method 100 then implements a simulated plant operation for a time period specified by the user, as shown in step 108. Specifically, the plant power output (in megawatts (MW)) is calculated for the selected operation mode. In addition, machine degradation information is updated, including the calculation of factored hours for the turbine components. Using this information, method 100 then projects a future estimated inspection date. When an inspection is needed, the simulated power plant is placed into an inspection mode and made unavailable for an appropriate time period.

Finally, as shown in step 110, the simulation results are analyzed and presented to the user in order to identify the best available tradeoffs between parts costs, lives and performance. Thereby, the user is assisted in reaching financially driven decisions such as allocation of new product introduction (NPI) investment capital, application of conversion modification upgrades (CMU's), and operations tactics (e.g., mode of operation) as a function of external dynamic variables (e.g., such as prices and weather).

Generally speaking, the simulations can be run and the results thereof may be presented to the user in two different modes, both of which utilize the same plant configurations, core engine and transfer functions. In a “snapshot mode”, an instantaneous set of external conditions are specified by the user and the simulation is run with a variety of internal settings so as to ascertain various local maxima (e.g., $/hr profit or lowest life consumption factor for a given minimum output) as well as corollary effects such as emissions changes and part life consumption rates. Thus, the snapshot mode uses the simulation engine to calculate the instantaneous earnings, as well as and cost rates for various study mode input conditions.

In a “profile mode”, a series of instantaneous external conditions is fed to the engine sequentially. The simulation engine then chooses an operating mode based on user inputted business rules (which may be honed by snapshot studies), maintenance, and degradation. Costs are tracked cumulatively, including outage events, and the results are stored for comparison of several related scenarios. Parameters that may be varied in scenarios include degradation rates, price schedules, individual component performance and business rules.

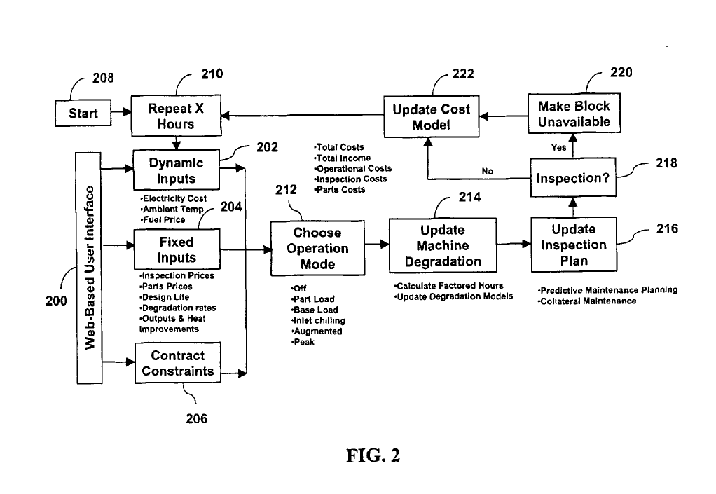

FIG. 2 is a block diagram illustrating the functional overview of the simulation engine portion of a web-based simulation tool configured in accordance with method 100. As can be seen, a web-based user interface (block 200) is used to input the plant operation information, including the dynamic inputs (block 202), the fixed inputs (block 204) and the contract constraints (block 206). When a simulation is begun (block 208), the user may designate further simulations to be run after a certain period of time (block 210). With the plant operation inputs, an operation mode is chosen (block 212), and the machine degradation information is updated (block 214) along with the inspection plan information (block 216).

If an inspection is determined to be needed (block 218), then the power plant block is made unavailable (block 220) by putting it into an inspection mode. The simulation engine will also look ahead to see whether the determined inspection date will coincide with a “blackout” period during which outages should not occur. If this is the case, then the actual inspection is should be scheduled before the blackout period. When an inspection is done, any collateral maintenance associated with the inspection is also done. After the inspection is complete, the block is made available again, and the operation cycle is repeated for the next operation period. At the end of the simulation period, the simulation tool updates the cost model (block 222) and may to present the results to the user in a variety of different formats, including line plots, bar charts, summary tables, as well as displaying the raw data. Further, the user also has the ability to extract the summary tables and raw data into comma separated files for external analysis with other applications.

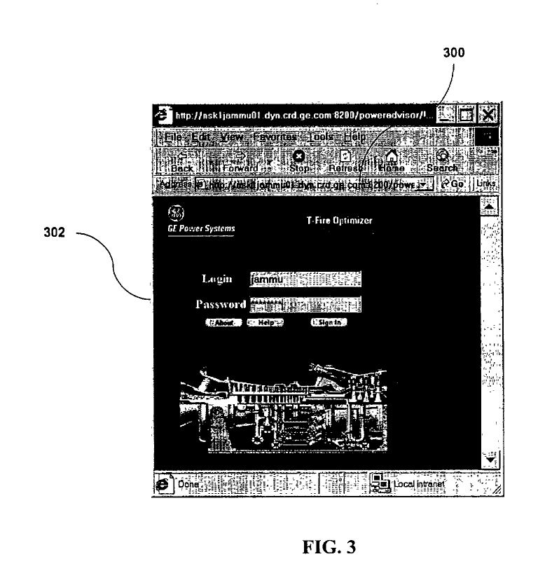

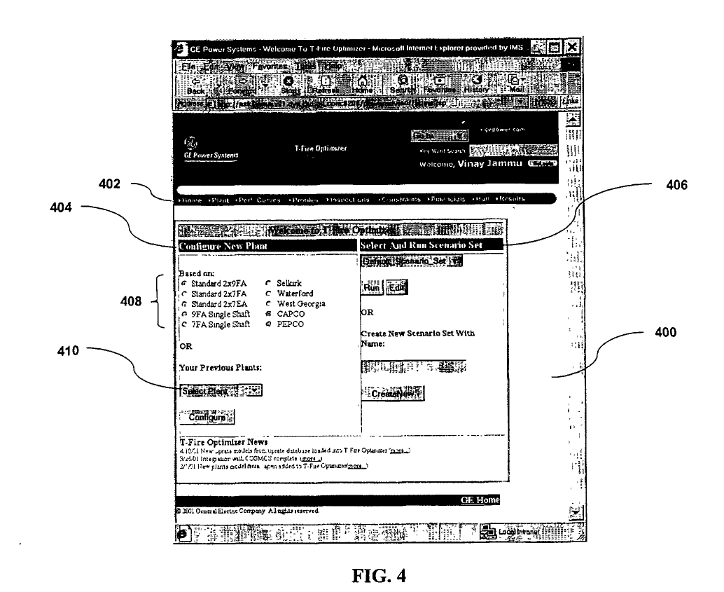

As previously stated, the simulation tool is accessible through a web-based user interface, which is preferably compatible with both Internet Explorer 5.0 and above and Netscape version 4.0 and above. FIG. 3 illustrates an exemplary screen shot of a login screen that may be used to access the simulation tool. As is shown, the simulation tool is associated with a URL (uniform resource locator) 300 that corresponds to a general login screen 302 that prompts the user for a username and password. Upon a successful login, the user is presented with a home screen 400, such as shown in FIG. 4, for example. The home screen 400 includes a menu bar 402, a plant configuration region 404, and a scenario select/run region 406.

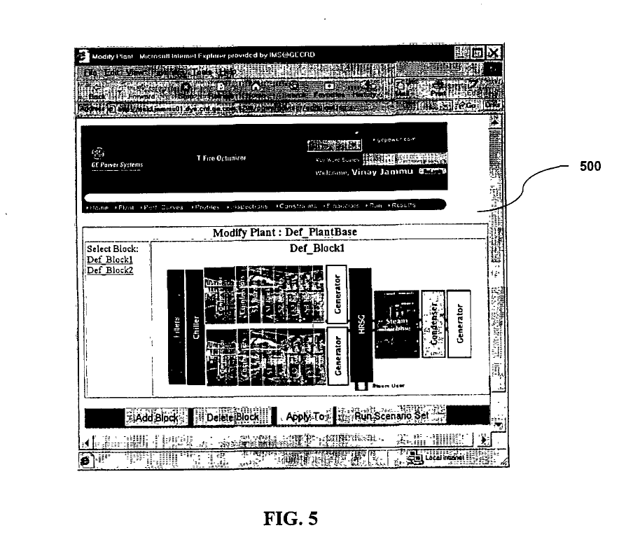

The plant configuration region 404 of the user interface allows for the configuration of a new power plant to be used in a simulation scenario. A new plant configuration may be based upon one of several standard plant configurations, as indicated by selections 408. Alternatively, the new plant may be based upon one or more previously user-configured plants, accessible through drop-down menu 410. An example of a screen shot 500 of a plant configuration option is shown in FIG. 5.

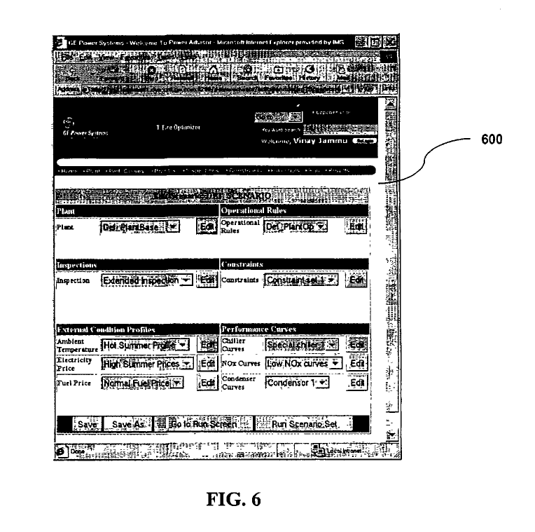

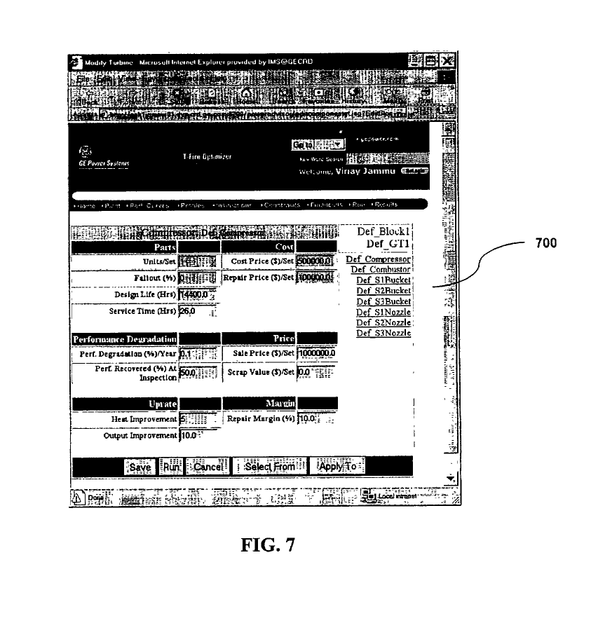

Referring again to FIG. 4, the scenario select/run region 406 allows a user to run or edit one of a list of default scenarios, as well as to create a new scenario set. FIG. 6 illustrates a screen shot 600 for editing a default scenario. In this screen, the user may input the dynamic inputs, fixed inputs and contract constraints as discussed previously. Each user input parameter is selected through a drop-down menu, wherein the individual selections may also be edited. In FIG. 7, the screen shot 700 illustrates a component edit feature in which the individual turbine generator component (e.g., a compressor) parameters are inputted/edited.

In running the simulations, the simulation engine portion of the simulation tool calculates plant output and component performance/lifing. With regard to performance modeling, commercially available software such as GateCycle™ and/or EfficiencyMap™, from GE Power Systems, may be implemented. In any case, the output/performance is calculated in terms of deviations from published specifications. The calculations are based on approximate models conforming to engineering models and have sufficient granularity (e.g., hourly, 3-hourly, daily etc.) so as to quantify analyses such as parts lives versus performance tradeoff, among others. Any deviations in output (due to heat rate or output improvement, for example) are then calculated based on the scenario data provided by the user.

The plant output calculations are based upon the operating mode thereof. In addition, the plant output is preferably calculated with “as new” components without degradation. The “as new” output may be then pro-rated to calculate the actual output by applying degradation factors between 0 and 1 for various components that degrade over time due to physical phenomena, such as compressor fouling. Further information regarding collecting and analyzing plant operational data may be found in U.S. Pat. No. 6,343,251 to Herron, et al. and commonly assigned to the assignee of the present application.

The simulation tool also features a cost account model in which the user has the ability to enter such parameters as cost price per set of parts, repair price per set of parts, repair margin, sale price per set of parts, scrap value per set of parts, an algorithm for booking revenue for contractual services, and services costs. Also, external conditions such as fuel price, electricity spot price, ambient temperature and usage profiles are also modeled.

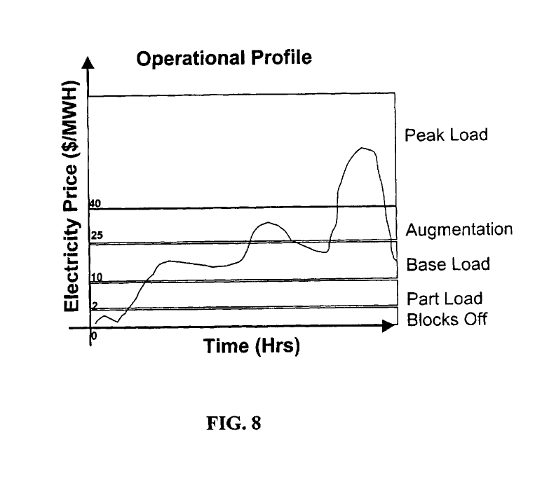

Various operational goals, such as profit and revenue maximization, may be explored through running scenarios. For example, FIG. 8 is a graph illustrating an exemplary operation profile for the purpose of maximizing revenue. The user defines the different modes the power plant block is to be in as a function of electricity prices. Thus, in this example, whenever the price of electricity is between $10 per megawatt-hour (MWH) and $25 per MWH, the power plant block is put in base load condition. As indicated previously, the simulation tool shall provide capability to do portfolio analysis, including running multiple scenarios for a plant in a single iteration or running multiple scenarios for multiple plants in single iteration.

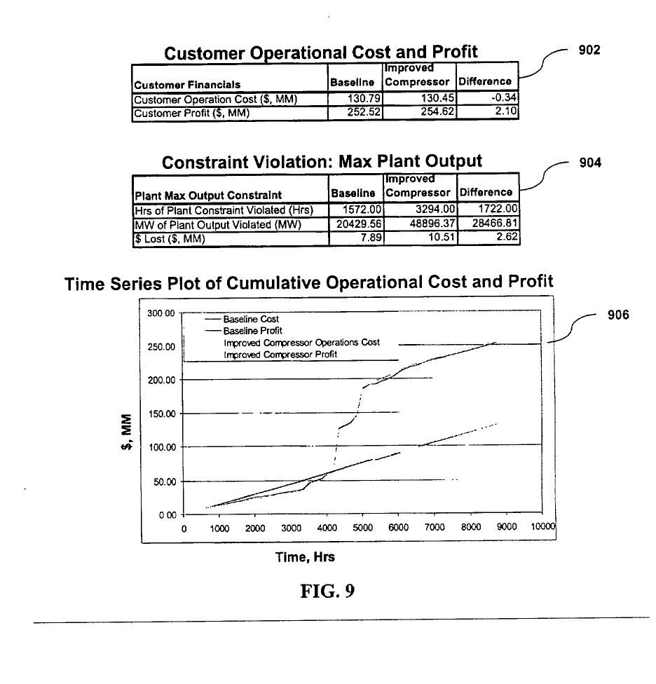

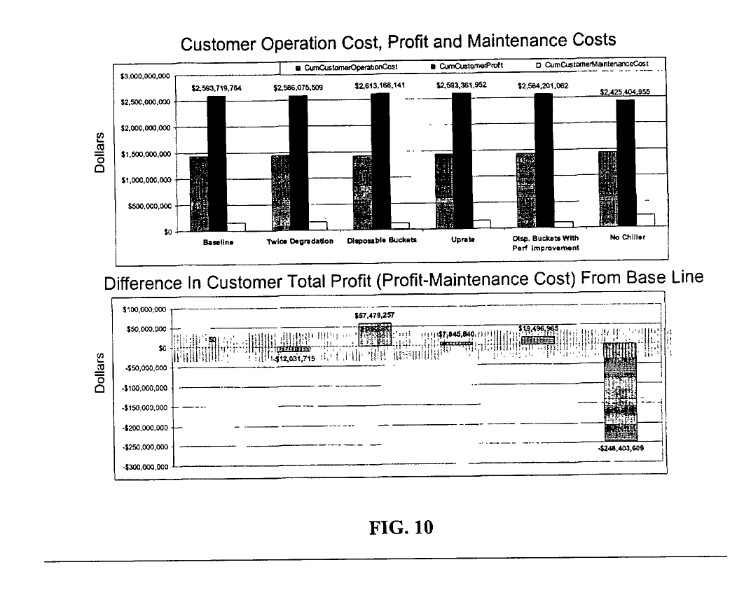

FIGS. 9 and 10 illustrate exemplary simulation outputs of the simulation tool that allow a user to perform trade-off and other types of analysis. In particular, FIG. 9 represents a simulation output of a scenario in which the benefits of procuring an improved compressor are assessed in view of a potential return on investment (ROI). A first table 902 compares the customer operational cost and customer profit both with the improved compressor and without the improved compressor (baseline). As is shown, using an improved compressor results in an operating cost decrease of $340,000 per year, combined with an increase of $2.1 million in customer profit per year as a result of an assumed 2% heat rate and 4% output improvement from the improved compressor.

However, a second table 904 illustrates a trade-off with respect to a contract constraint violation; that is, the effect of the improved output on the amount of time the increased plant output violates the constraints. As shown in the example, the baseline plant operation already results in 1572 hours per year that the plant output capacity exceeds output constraints, translating into $7.89 million in lost revenue. With the improved compressor, the output constraint violation more than doubles, to 3294 hours. This in turn results in an additional $2.62 in additional lost revenue due to violation of maximum plant constraints. Accordingly, the tables generated as a result of this scenario will assist a user in performing a trade-off analysis to determine whether the procurement of an improved compressor will provide sufficient ROI. In addition to tabular form, the simulation tool also provides for bar charts and time-based line plots, as shown by plot 906 in FIG. 9. Additional types of charts may also be generated by a user by exporting the simulation data to a spreadsheet program, such as Excel.

Finally, FIG. 10 is a pair of bar charts illustrating and comparing a variety of plant operating scenarios, from the perspective of profitability to a customer of turbine generation equipment. Scenario 1 (Baseline) represents baseline plant operation. In scenario 2 (Twice Degradation), it is assumed that the degradation rates of the plant components are twice that of the baseline. Scenario 3 (Disposable Buckets) analyzed a plant having disposable turbine buckets for stage 1 and 2. It is assumed that the bucket price and maintenance cost is reduced by a factor of 1/3, but that the total bucket life is decreased to 24,000 hours. In scenario 4 (Uprate), the output improvement for all hot gas path (HGP) components is increased by 0.3% and the heat improvement is increased by 0.1% with respect to the baseline. However, the cost and price of HGP parts is increased by a factor of 1/3. In scenario 5 (Disposable Buckets With Improved Performance), the bucket cost, price and total life is the same as Scenario 3, and with the stage 1 buckets having an output improvement of 0.2% and a heat rate improvement of 0.1%. The stage 2 buckets have an output improvement of 0.1% and a heat rate improvement of 0.05%. Lastly, scenario 6 covers a situation where the plant is without inlet chilling capability.

As can be seen from the lower chart in FIG. 10, some scenarios result in a higher total customer profit as compared with the baseline, and other scenarios result in a lower total profit as compared with the baseline. Such information may then be used to make operating/upgrade economic decisions. In this example, it is seen that where there is a degradation rate of components twice that of the baseline, there is a decrease in total profit. However, when the customer operates the plant without the use of an inlet chiller, there is a significant decrease in total profit (over $248 million) for the customer as compared to the baseline. This is a result of the plant spending more time in a peak load and augmented operating mode.

It will be appreciated that the simulation outputs shown in FIGS. 9 and 10 represent are exemplary only and represent a small fraction of the various types of outputs possible by using the simulation tool. For example, the multiple scenario simulation of FIG. 10 could be used to generate several different types of charts and/or graphs, such as hour-to-hour variations in price, operation mode, factored hours, etc.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for analyzing operational performance of industrial power plant machinery, the method comprising:
receiving an input configuration for a power plant to be analyzed;
receiving inputted power plant operational information;
running a simulated power plant operation for a specified period of time, based upon said power plant input configuration and said inputted power plant operational information; and
outputting simulated results of said simulated power plant operation in accordance with selected economic parameters of said power plant.

2. The method of claim 1, wherein said input configuration and said inputted power plant operational information is received through a web-based user interface.

3. The method of claim 2, wherein said inputted power plant operational information includes dynamic inputs, fixed inputs and contract constraints.

4. The method of claim 2, wherein said selected economic parameters of said power plant include parts cost, parts life and parts performance.

5. The method of claim 2, wherein said input configuration for a power plant to be analyzed is based upon a selected power plant configuration from a menu included in said web-based user interface.

6. The method of claim 2, further comprising determining an operational profile of said power plant, said operational profile being determined in accordance with user inputted operational rules.

7. The method of claim 2, further comprising:
updating machine degradation data;
updating an inspection plan;
determining, from said updated inspection plan, whether an inspection is required; and
if an inspection is required, then placing said power plant into an inspection mode in which said power plant is unavailable during said simulated power plant operation for a period of time coinciding with an actual inspection.

8. The method of claim 2, further comprising using said simulated results of said simulated power plant operation to evaluate the value of new product introduction (NPI) with respect to additional performance thereof versus the cost thereof.

9. The method of claim 2, further comprising using said simulated results of said simulated power plant operation to evaluate the value of conversion, modification and upgrade (CMU) of components with respect to additional performance thereof versus the cost thereof.

10. The method of claim 2, further comprising using said simulated results of said simulated power plant operation for evaluating a trade-off analysis of component life to performance.

11. A simulation tool for analyzing operational performance of industrial power plant machinery, the simulation tool comprising:
a user interface for inputting a power plant configuration and for inputting power plant operational information; and
a simulation engine for running a simulated power plant operation for a specified period of time, based upon said power plant configuration and said power plant operational information;
wherein simulated results of said simulated power plant operation are outputted in accordance with selected economic parameters of said power plant.

12. The simulation tool of claim 11, wherein said input configuration and said inputted power plant operational information is received through a web-based user interface.

13. The simulation tool of claim 12, wherein said inputted power plant operational information includes dynamic inputs, fixed inputs and contract constraints.

14. The simulation tool of claim 12, wherein said selected economic parameters of said power plant include parts cost, parts life and parts performance.

15. The simulation tool of claim 12, wherein said input configuration for a power plant to be analyzed is based upon a selected power plant configuration from a menu included in said web-based user interface.

16. The simulation tool of claim 12, wherein said simulation engine determines, in accordance with user inputted operational rules, an operational profile of said power plant.

17. The simulation tool of claim 12, wherein said simulation engine updates machine degradation data and updates an inspection plan, and said simulation engine further determines, from said updated inspection plan, whether an inspection is required, wherein if an inspection is required, then said simulation engine further places said power plant into an inspection mode in which said power plant is unavailable during said simulated power plant operation for a period of time coinciding with an actual inspection.

18. The simulation tool of claim 12, wherein said simulated results of said simulated power plant operation provide data for evaluation of the value of new product introduction (NPI), with respect to additional performance thereof versus the cost thereof.

19. The simulation tool of claim 12, wherein said simulated results of said simulated power plant operation provide data for evaluation of the value of conversion, modification and upgrade (CMU) of components, with respect to additional performance thereof versus the cost thereof.

20. The simulation tool of claim 12, wherein said simulated results of said simulated power plant operation provide data for evaluation of a trade-off analysis of component life to performance.
